(19) United States
(12) Patent Application Publication
(10) Pub. No.: US 2007/0080932 A1
(43) Pub. Date: Apr. 12, 2007

(54) Wireless projector and method of scanning signal receiving units thereof

(75) Inventors: Chih-Wei Yang, Rende Township (TW); Chang-Hao Lee, Yonghe City (TW); Chih-Yang Wang, Jhonghe City (TW)

Correspondence Address: RABIN & Berdo, PC, 1101 14TH STREET, NW, SUITE 500, WASHINGTON, DC, 20005, US

(73) Assignee: BenQ Corporation

(21) Appl. No.: 11/480,476

(22) Filed: Jul. 5, 2006

(30) Foreign Application Priority Data
Oct. 6, 2005 (TW) 94134996

(51) Int. Cl. G09G 5/00

(52) U.S. Cl. 345/156

(57) ABSTRACT

A wireless projector is provided. The wireless projector includes a microprocessor, a wireless module, a projecting module and several signal receiving units. The wireless module includes at least one image signal line electrically connected to the microprocessor. The projecting module is also electrically connected to the microprocessor to project an image. The microprocessor determines whether an external signal is connected to the wireless module and determines whether to scan the other signal receiving units. Thus, the microprocessor can detect and differentiate signals of various sources.

This application claims the benefit of Taiwan application Ser. No. 94134996, filed Oct. 6, 2005, the subject matter of which is incorporated herein by reference.

### BACKGROUND OF THE INVENTION

1. Field of the Invention

The invention relates in general to a projector, and more particularly to a wireless projector.

2. Description of the Related Art

Current wireless projectors use a built-in or an attached wireless module to transmit or receive signals. Referring to FIG. 1A, a block diagram of a conventional wireless module and a conventional projecting module is shown. The wireless projector 100 includes a wireless module 101, a microprocessor 102, a projecting module 105 and several signal receiving units 107. The wireless module 101 receives an image. The image is transmitted to the projecting module 105 to be projected through the microprocessor 102. Examples of the signal receiving units include RGB signal receiving unit, DVI signal receiving unit, AV signal receiving unit or S-video signal receiving unit. The RGB signal receiving unit is used for receiving analog image signals. The DVI signal receiving unit is used for receiving digital image signals. The AV signal receiving unit and the S-video signal receiving unit are used for receiving AV signals of TV or DVD. The signal receiving units 107 can transmit signals to the projecting module 105 through the microprocessor 102.

Referring to FIG. 1B, a block diagram illustrating the sequence of signal receiving units scanned by a conventional wireless projector is shown. The microprocessor 102 scans the signal receiving units in the sequence of the RGB signal receiving unit 107a, the DVI signal receiving unit 107b, the AV signal receiving unit 107c and the S-video signal receiving unit 107d. In terms of the projector 100, the wireless module 101 is itself a signal receiving unit. When the user activates the wireless projector 100, the wireless module 101 is activated as well and will directly transmit the signals to the microprocessor 102. The microprocessor 102 decides that the joint of a signal receiving unit has been occupied, and will not scan the other signal receiving units. However, the user does not have to use the wireless module 101 to transmit the frame, but rather, the user wants to view the frame of DVD or TV projected by the projector 100. Under such circumstances, since the microprocessor 102 has already decided that the signal receiving unit is occupied, the microprocessor 102 will not scan the AV signal receiving unit or the S-video signal receiving unit. The user has to press the press-key of the AV signal receiving unit or the S-video signal receiving unit so as to switch the signal receiving unit and the wireless module 101 to the AV signal receiving unit or the S-video signal receiving unit. This is indeed very troublesome to the user in terms of use.

When the user has finished viewing the DVD and unplugged the AV signal receiving unit or the S-video signal receiving unit, the microprocessor 102 will search for the signal receiving unit again. In the wireless projector, the signal receiving unit for receiving signals from wireless networks is always power on, so the microprocessor 102 will immediately receive the wireless module 101 and become a new signal receiving unit despite not any external signal line is connected to the wireless module. The other signal receiving units will never be scanned unless the user presses the corresponding press-key of the desired signal receiving unit. This is very inconvenient to the user.

### SUMMARY OF THE INVENTION

It is therefore an object of the invention to provide a wireless projector and the method of scanning the signal receiving units thereof. The user does not need to press the press-key in order to switch to the correct signal receiving unit. Thus, the wireless projector can precisely detect the signal source of the current signals.

The invention achieves the above-identified object by providing a wireless projector. The wireless projector includes a microprocessor, a wireless module, a projecting module and several signal receiving units. The wireless module is electrically connected to the microprocessor. The projecting module is also electrically connected to the microprocessor to project an image. The microprocessor determines whether an external signal is connected to the wireless module and then determines whether to scan other signal receiving units.

The invention further achieves the above-identified object by providing a method for a wireless projector to scan several signal receiving units. The wireless projector includes a microprocessor, a wireless module, a projecting module, the signal receiving units and at least one transmission line. The wireless module and the projecting module are electrically connected to the microprocessor. The signal receiving unit is electrically connected to or wirelessly communicated with the microprocessor. The method includes the following steps. Firstly, the microprocessor collects the information of the models of the signal receiving units. Then, one of the signal receiving units is scanned. Next, whether one of the signal receiving units is the wireless module is determined. If the signal receiving unit is determined to be the wireless module, then the microprocessor inquires the wireless module through the transmission line. Afterwards, whether an external signal is connected to the wireless module is determined. Lastly, if not any external signal is determined to be connected to the wireless module, then continue to scan another one of the signal receiving units.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a block diagram of a conventional wireless module and a conventional projecting module;

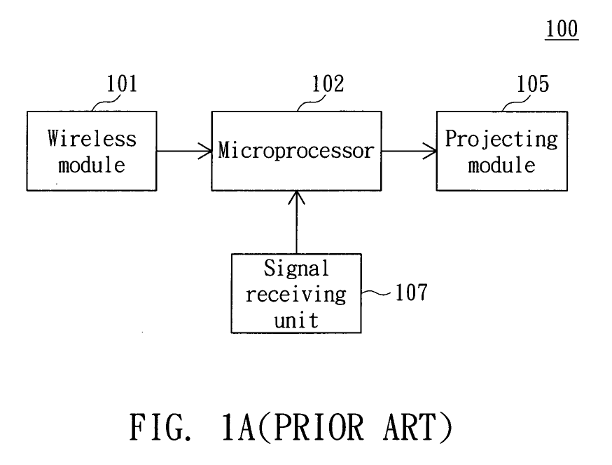

FIG. 1B (Prior Art) is a block diagram illustrating the sequence of signal receiving units scanned by a conventional wireless projector;

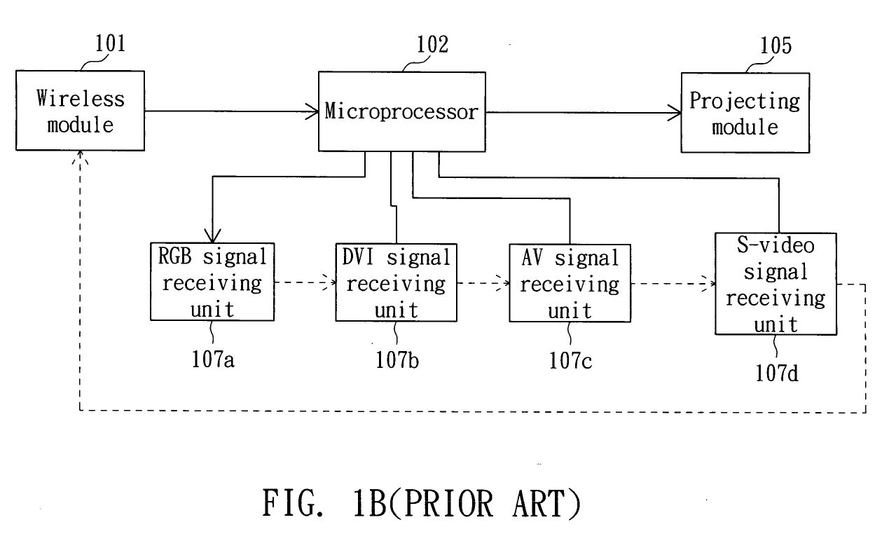

FIG. 2 is a block diagram of the wireless projector;

FIG. 3 is a flowchart illustrating signal scanning of a projector microprocessor;

FIG. 4 is a flowchart illustrating the wireless module answering the projector microprocessor; and

FIG. 5 is a diagram of the projection on a screen.

### DETAILED DESCRIPTION OF THE INVENTION

After the wireless projector is initialized or any of the signal receiving units (such as the presently used signal receiving unit) is turned off, the source of the signal receiving units will be scanned. The signal receiving unit is the interface between the projector and external sources. The wireless module, that is, another signal receiving unit, has always been transmitting signals to the microprocessor, so that the microprocessor decides that the wireless module is a signal receiving unit. With the function that enables the microprocessor to determine whether an external signal or a user is connected to the wireless module, the microprocessor of the invention can continue to scan the sources of the signal receiving units. Two ways for the microprocessor to be equipped with the function of determining whether the wireless module is connected to an external signal or a user are disclosed below.

### First Embodiment

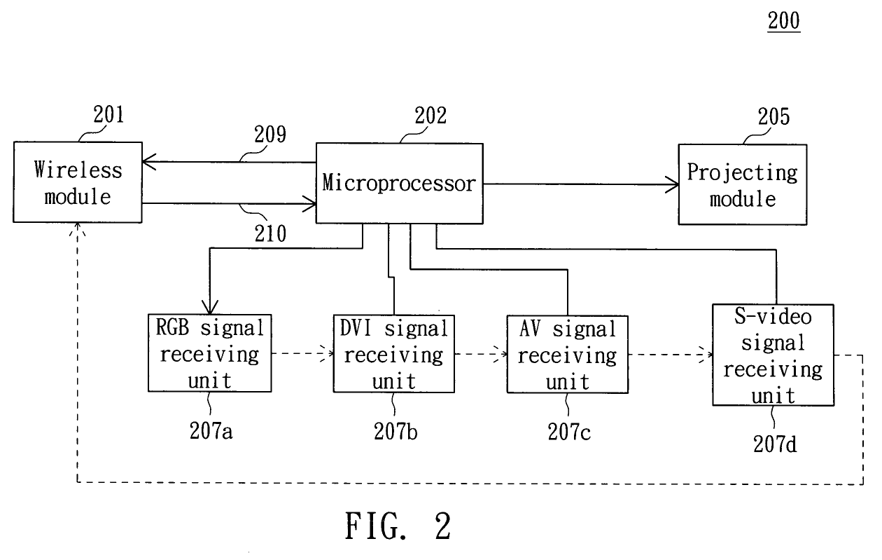

Referring to FIG. 2, a block diagram of the wireless projector is shown. The wireless projector 200 includes a microprocessor 202, a wireless module 201, a projecting module 205, several signal receiving units, a transmission line 209 and an image signal line 210. The wireless module 201 is electrically connected to the microprocessor 202. The projecting module 205 is also electrically connected to the microprocessor 202. The user can transmit the computer images to the microprocessor 202 through the image signal line 210. Then, the computer frames received by the wireless module 201 are projected on a screen by the projecting module 205.

Examples of several signal receiving units include the RGB signal receiving unit 207a, the DVI signal receiving unit 207b, the AV signal receiving unit 207c and the S-video signal receiving unit 207d. The RGB signal receiving unit 207a is mainly used for transmitting or receiving analog image signal, and the DVI signal receiving unit 207b is mainly used for transmitting or receiving digital image signal. The AV signal receiving unit 207c or the S-video signal receiving unit 207d is used for receiving the AV signals. By means of different signal receiving units, the projector 200 is able to project the images coming from of various sources such as computer, TV or DVD.

With an extra transmission line 209 being installed to connect the wireless module 201 and the microprocessor 202, the microprocessor 202 is not only capable of receiving the signals from the wireless module 201 but also capable of transmitting inquiry signals to the wireless module 201, so that two-way function of transmission and reception is achieved. Examples of the transmission line include a communication interface complying with the I²C, GPIO or RS-232 protocols. The transmission line 209 is preferably the RS-232 interface transmission line 209 for providing a large amount of transmission. The disclosure below exemplifies how to enable the microprocessor 202 to efficiently control the sequence of scanning the signal receiving units by means of the transmission line 209.

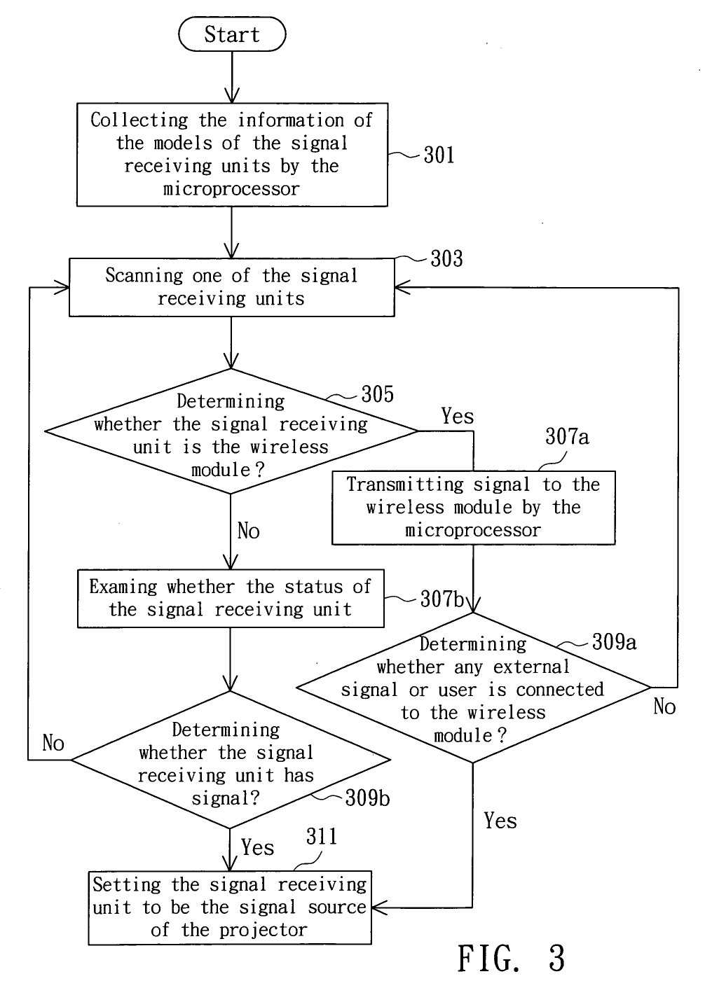

Referring to FIG. 3, a flowchart illustrating signal scanning of a projector microprocessor is shown. Firstly, the method begins at step 301, the microprocessor collects the information of the sources of the signal receiving units. Next, proceed to step 303, one of the signal receiving units is scanned. Then, proceed to step 305, whether one of the signal receiving units is a wireless module is determined. If yes, proceed to step 307a, the microprocessor 202 transmits signals to the wireless module 201, and continue to perform step 309a to determine whether any external signal or user is connected to the wireless module 201. If not any external signal or user is connected to the wireless module 201, return to step 303 and continue to scan the other signal receiving units; if an external signal or user is connected to the wireless module 201, directly perform step 311 to set the wireless module 201 as the signal source of the projector 200.

In step 305, if the source of the signal receiving units is determined to be not the wireless module 201, proceed to step 307b to examine the status of the signal receiving unit, and then proceed to step 309b to determine whether the signal receiving unit has a signal. If there is no signal, return to step 303 and continue to scan the another one of the signal receiving units; if there is a signal, perform the last step, that is, step 311, the signal receiving unit is set as the signal source of the projector 200.

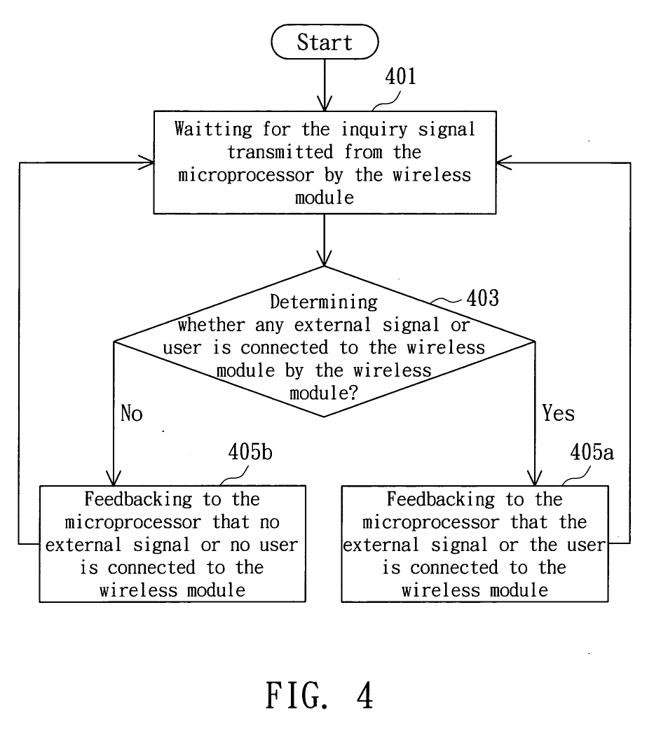

In response to the scanning procedure of the microprocessor, the wireless module 201 performs the next steps. Referring to both FIG. 3 and FIG. 4. FIG. 4 is a flowchart illustrating the wireless module feedbacks the projector microprocessor. In step 307a of FIG. 3, the microprocessor 202, through the transmission line 209, inquires the wireless module 201 whether a user or any external signal is connected to the wireless module 201. In step 401, the wireless module 201 is waiting for the inquiry signal transmitted by the microprocessor 202. After an inquiry signal is generated, then proceed to step 403, the wireless module 201 determines whether any external signal or user is connected to the wireless module 201. If any external signal or user is connected, proceed to step 405a to feedback to the microprocessor 202 of the projector 200 that an external signal or user is connected to the wireless module 201, and return to step 401 of waiting for the next inquiry signal; if not any external signal or user is connected to the wireless module, proceed to step 405b to feedback to the microprocessor 202 that no external signal is connected thereto and no user is connected to the wireless module 201, and then return to the step 401 of waiting for the next inquiry signal.

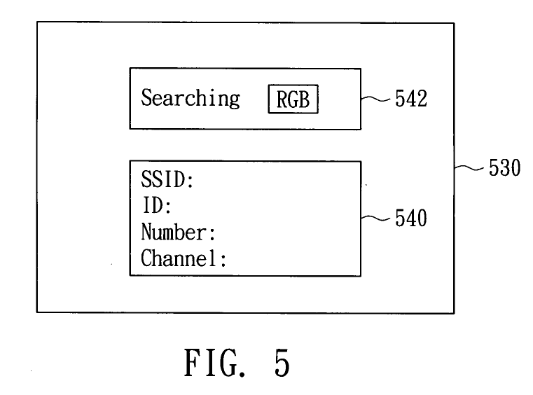

Besides, with the installation of the transmission line, the wireless module 201 can carry more information to the microprocessor of the projector. Therefore, the projecting module 205 can project the information of the wireless module 201 on the screen 530. Referring to FIG. 5, a diagram of the projection on a screen is shown. The projection screen has an information display area 540 and a scanning progress area 542. The items of information of the wireless module 201 such as the service set identifier (SSID), the channel and the Internet protocol address (IP) are disclosed in the information display area 540 and fixed on the screen. Since these items of information remain being displayed on the screen until the microprocessor has scanned the signal receiving unit and displayed the user frame. Therefore, the user can obtain the basic information of the wireless module 201 to process the setting of the network connection of the computer, avoiding being unable to record the basic information of the wireless module 201 and use the wireless transmission when the basic information of the wireless module 201 is displayed for an instant only.

### Second Embodiment

Referring to FIG. 2 again. In the first embodiment, the wireless module and the microprocessor are enabled to have two-way communication through the transmission line. In the second embodiment, the information of whether the any external signal or user is connected the wireless module 201 is transmitted to the microprocessor 202 through the image signal line 210. The method determines whether the any external signal or user is connected the wireless module 201 according to the voltage level at the pin of the joint connecting the microprocessor 202 and the wireless module 201. For example, if any one is connected to the wireless module 201, then the voltage level at a certain pin of the wireless module 201 will be changed and transmitted to the microprocessor 202 through the image signal line 210. The microprocessor 202 can detect the change in the voltage level and determine the present signal receiving unit to be the wireless module 201. On the contrary, if no one is connected, the microprocessor 202 can continue to scan the other signal receiving units.

Apart from the two embodiments disclosed above, no matter how the wireless module and the projector communicate with each other, as long as the projector is able to detect whether a user uses the wireless module for wireless network transmission or any external signal is connected to the wireless module, thereby determining whether to continue with the scanning of the signal receiving unit is within the scope of the invention.

According to the wireless projector disclosed in above embodiments of the invention, whether the signal showing the connection between an external signal and the wireless module is generated or not is determined by the microprocessor, so that the microprocessor will not take the wireless module for the signal receiving unit when the wireless module is activated but not connected to any user. Thus, the user does not need to spend time pressing on the corresponding press-key of the desired signal receiving unit in order to be switched to the desired signal receiving unit, which is more convenient in terms of use. Besides, through the installation of the transmission line, the wireless module is able to transmit more connection setting information of the wireless module to the projecting module, and project these items of information on the screen, thus facilitating the user with the setting of wireless network.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless projector, comprising:
a microprocessor;
a wireless module comprising at least one image signal line for electrically connecting to the microprocessor;
a projecting module electrically connected to the microprocessor, wherein the projecting module is used to project an image; and
a plurality of signal receiving units electrically connected to the microprocessor;
wherein the microprocessor determines whether an external signal is connected to the wireless module and then determines whether to scan the signal receiving units.

2. The wireless projector according to claim 1, further comprising:
at least a transmission line whose two ends are respectively connected to the wireless module and the microprocessor, wherein through the transmission line, the microprocessor determines whether the external signal is connected to the wireless module.

3. The wireless projector according to claim 2, wherein the transmission line complies with the RS-232 communication protocol.

4. The wireless projector according to claim 2, wherein the transmission line complies with the I²C communication protocol.

5. The wireless projector according to claim 2, wherein the transmission line complies with the GPIO communication protocol.

6. The wireless projector according to claim 1, wherein one of the signal receiving units is selected from one of an AV signal receiving unit, an S-video signal receiving unit, an RGB signal receiving unit or a DVI signal receiving unit.

7. A method for a wireless projector to scan a plurality of signal receiving units by a wireless projector, the wireless projector comprising a microprocessor, a wireless module, a projecting module, and the signal receiving units, wherein the projecting module is electrically connected to the microprocessor, the signal receiving units is electrically connected to or wirelessly communicated with the microprocessor, and the method comprises:
collecting the information of the models of the signal receiving units by the microprocessor;
scanning one of the signal receiving units;
determining whether the signal receiving unit is the wireless module;
inquiring the wireless module through the transmission line by the microprocessor if the signal receiving unit is determined to be the wireless module;
determining whether an external signal is connected to the wireless module; and
scanning another one of the signal receiving units if not any external signal is determined to be connected to the wireless module.

8. The method according to claim 7, further comprising:
examining whether the signal receiving unit has a signal if the receiving unit is determined to be not the wireless module.

9. The method according to claim 8, wherein if the signal receiving unit is determined to have the signal, the signal receiving unit is set to be the signal source of the wireless projector.

10. The method according to claim 7, further comprising:
setting the wireless module to be the signal receiving unit of the wireless projector if the external signal is determined to be connected to the wireless module.

11. The method according to claim 10, further comprising:
transmitting a connection setting information to the projecting module by the wireless module after setting the wireless module to be the signal receiving unit of the wireless projector.

12. The method according to claim 11, wherein the connection setting information comprises a service set identifier (SSID) of the wireless module.

13. The method according to claim 11, wherein the connection setting information comprises a channel of the wireless module.
